(19) United States
(12) Patent Application Publication
(10) Pub. No.: US 2024/0168499 A1
(43) Pub. Date: May 23, 2024

(54) TRANSPORT CARRIAGE

(71) Applicants: MAEBASHI INSTITUTE OF TECHNOLOGY, Maebashi-shi, Gunma (JP); SANDEN RETAIL SYSTEMS CORPORATION, Isesaki-shi, Gunma (JP)

(72) Inventors: Chi ZHU, Maebashi-shi, Gunma (JP); Peirang LI, Maebashi-shi, Gunma (JP); Hideki KIMURA, Isesaki-shi, Gunma (JP); Mototaka TAJIKA, Isesaki-shi, Gunma (JP); Masaru TSUNODA, Isesaki-shi, Gunma (JP)

(21) Appl. No.: 18/281,557

(22) PCT Filed: Mar. 1, 2022
(86) PCT No.: PCT/JP2022/008520

§ 371 Date: Sep. 11, 2023

(30) Foreign Application Priority Data
Mar. 26, 2021 (JP) 2021-052880

(51) Int. Cl. G05D 3/12; B62B 3/02; B66F 7/06; H02K 7/06; H02K 7/116

(52) U.S. Cl. CPC G05D 3/12; B62B 3/022; B66F 7/0608; B66F 7/0666; H02K 7/06; H02K 7/116; B62B 2206/003; B62B 2206/06

(57) ABSTRACT

A cart that reduces impact on a load placed on a loading platform 50. The cart 10 includes a drive that raises/lowers the platform 50 by rotating a motor which extends/retracts a mechanism 70 vertically. The drive rotates the motor when an external force raises/lowers the platform 50 and extends/retracts the mechanism 70. When a control device detects lowering of the platform 50 held at a predetermined vertical position and detects an increase in weight of the load on the platform 50 based on an output signal of a rotation sensor that detects rotation of the motor and an output signal of a current sensor that detects a drive current of the motor, the control device controls the motor such that the platform 50 is raised and held at the either the predetermined vertical position or a vertical position lower than that position.

### TECHNICAL FIELD

The present invention relates to a cart that can raise and lower its loading platform.

### BACKGROUND ART

As an example of this kind of carts, Patent Document 1 discloses a cart that raises and lowers its loading platform by extending and retracting its lifting arms (X-shaped arms) with its electric cylinder (electric actuator).

### REFERENCE DOCUMENT LIST

### Patent Document

Patent Document 1: JP 2010-274704 A

### SUMMARY OF THE INVENTION

### Problem to be Solved by the Invention

As to a cart that can raise and lower its loading platform, such loading platform is normally held and fixed at predetermined vertical positions, such as at its highest position or an intermediate position between its highest position and its lowest position. Thus, this kind of carts has a problem in that, when a load is placed on the loading platform, the load tends to receive an impact from the loading platform.

Thus, an object of the present invention is to provide a cart that can reduce impacts that a load receives when the load is placed on its loading platform.

### Means for Solving the Problem

In one aspect of the present invention, a novel cart is provided. The cart includes a base having a lower part to which a wheel is attached, a loading platform that is disposed above the base, an extendable mechanism that is disposed between the base and the loading platform and that is capable of vertically extending and retracting, a drive device that raises and lowers the loading platform by rotating an electric motor and consequently extending and retracting the extendable mechanism vertically, a rotation sensor that detects the rotation of the electric motor and outputs a signal, a current sensor that detects a drive current of the electric motor and outputs a signal, and a control device that controls the electric motor such that the loading platform is raised or lowered to a predetermined vertical position based on an operation command and such that the loading platform is held at the predetermined vertical position. The drive device has a back drive property that rotates the electric motor when an external force raises or lowers the loading platform and consequently extends or retracts the extendable mechanism. When the control device detects lowering of the loading platform held at the predetermined vertical position and detects an increase in weight of a load placed on the loading platform based on the output signals of the rotation sensor and the current sensor, the control device controls the electric motor such that the lowered loading platform is raised and held at the predetermined vertical position or is held at a vertical position lower than the predetermined vertical position.

### Effects of the Invention

According to the present invention, there is provided a cart that can reduce impacts that a load receives when the load is placed on its loading platform.

### BRIEF DESCRIPTION OF THE DRAWINGS

FIG. 1 is a front view of a cart according to a first example of the present invention.

FIG. 2 is a rear view of the cart according to the first example.

FIG. 3 is a view of the cart according to the first example from the right.

FIG. 4 is a view of the cart according to the first example from the left.

FIG. 5 is a perspective view illustrating a base and a handle of the cart according to the first example.

FIG. 6 is a view of the construction of an extendable mechanism of the cart according to the first example from the right.

FIG. 7 is a view of the extendable mechanism from the left.

FIG. 8 is a perspective view of the extendable mechanism.

FIG. 9 is a view of a drive device that drives the extendable mechanism from the right.

FIG. 10 is a view of the drive device from the left.

FIG. 11 is a top view seen from an arrow A in FIG. 9.

FIG. 12 illustrates a schematic configuration of a control device that controls the drive device.

FIG. 13 illustrates the state of the extendable mechanism and the drive device when a loading platform is located at its lowest position.

FIG. 14 illustrates the state of the extendable mechanism and the drive device when the loading platform is located at an intermediate position.

FIG. 15 illustrates the state of the extendable mechanism and the drive device when the loading platform is located at its highest position.

FIG. 16 illustrates a result of a comparison between the cart and a conventional cart of the same kind.

FIG. 17 illustrates an operation example of the cart according to the first example when a load is placed on the loading platform.

FIG. 18 illustrates an operation example of the cart according to the first example when a load is removed from the loading platform.

FIG. 19 is a view of a cart according to a second example of the present invention from the right.

FIG. 20 illustrates an operation example of the cart according to the second example when a load is placed on a loading platform.

FIG. 21 illustrates an operation example of the cart according to the second example when a load is removed from the loading platform.

FIG. 22 illustrates another shape of a guide hole in a guide member of the drive device.

### MODE FOR CARRYING OUT THE INVENTION

Hereinafter, examples of the present invention will be described with reference to the accompanying drawings.

### First Example

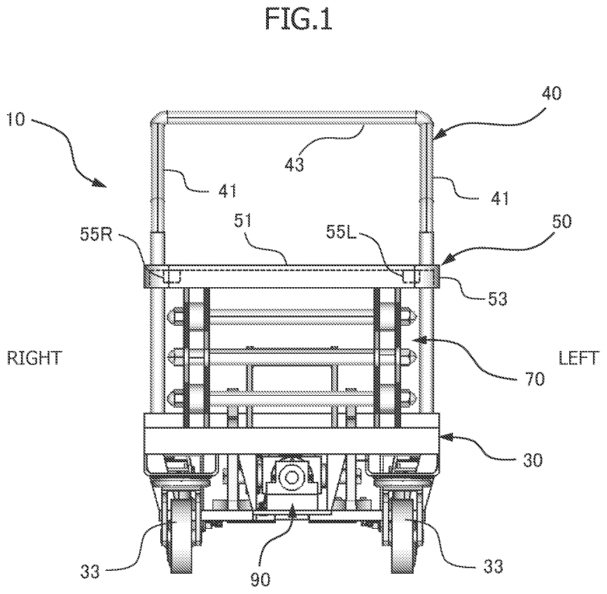

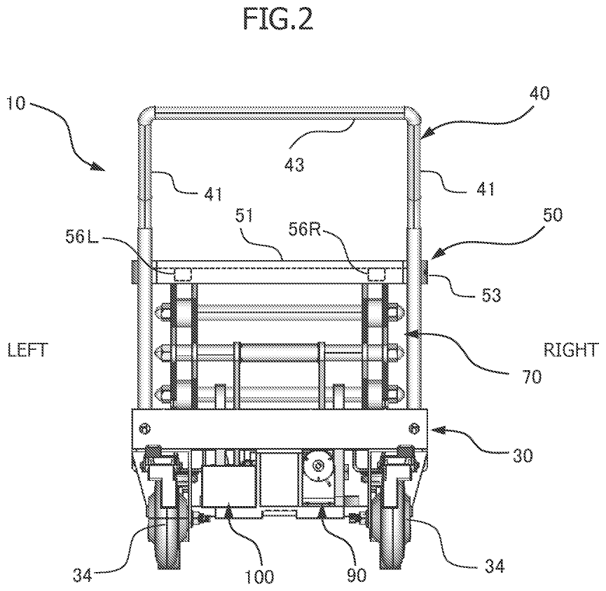

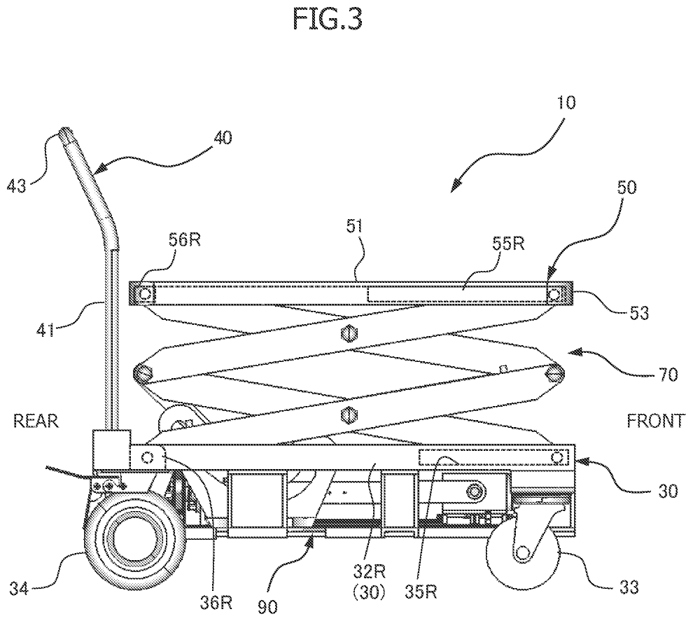

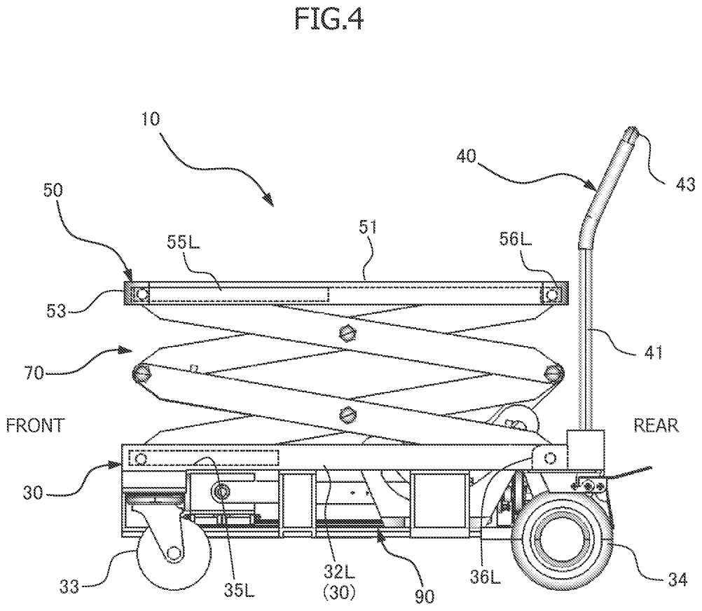

FIGS. 1 to 4 illustrate the construction of a push handle cart 10 according to a first example of the present invention. FIG. 1 is a front view of the cart 10, FIG. 2 is a rear view of the cart 10, FIG. 3 is a view of the cart 10 from the right, and FIG. 4 is a view of the cart 10 from the left.

As illustrated in FIGS. 1 to 4, the cart 10 according to this example includes a base 30, a push handle 40 (hereinafter referred to as “handle”), a loading platform 50 disposed above the base 30, an extendable mechanism 70 disposed between the base 30 and the loading platform 50, a drive device 90 that drives (extends and retracts) the extendable mechanism 70, and a control device 100 that controls the drive device 90.

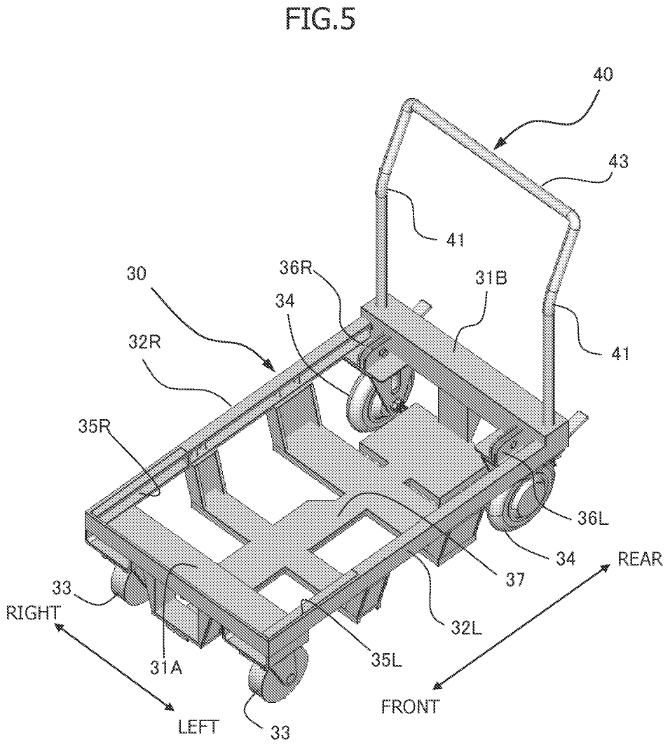

FIG. 5 is a perspective view, mainly illustrating the base 30 and the handle 40 of the cart 10.

As illustrated in FIG. 5, the base 30 is formed as a rectangular frame. The base 30 includes a front frame member 31A and a rear frame member 31B extending laterally, and a pair of right and left frame members (a left frame member 32L and a right frame member 32R) extending longitudinally. Swivel caster wheels (front wheels) 33, 33 are attached to lower parts at the two front corners of the four corners of the base 30. In addition, electrically driven wheels (rear wheels) 34, 34, into which, for example, in-wheel motors are incorporated, are attached to lower parts at the two rear corners.

In addition, a left rail part 35L extending longitudinally is formed on the front inner surface of the left frame member 32L of the base 30. Similarly, a right rail part 35R, which pairs with the left rail part 35L, is formed on the front inner surface of the right frame member 32R. In addition, a pair of attachment parts (a left attachment part 36L and a right attachment part 36R), which are separated from each other laterally, are formed on the rear side of the base 30. Furthermore, an installation part 37, on which the drive device 90 and the control device 100 are disposed, is formed inside the base 30 at a position lower than the base 30.

The handle 40 is attached to the rear frame member 31B such that the handle 40 stands on the rear frame member 31B. The handle 40 is, for example, a pipe member, and is formed to have an approximately gate shape (an approximately inverted U-shape). Specifically, the handle 40 has a pair of right and left supporting parts 41, 41, which first approximately vertically extend upward from the rear frame member 31B and next extend diagonally backward. The handle 40 also has a grip part 43, which approximately horizontally extends between end parts of the right and left supporting parts 41. The grip part 43 is held by an operator or the like (hereinafter simply referred to as “operator”) that mainly uses the cart 10.

Referring back to FIGS. 1 to 4, the loading platform 50 has a rectangular top board part 51, and a load (not illustrated) is placed on the top surface of the top board part 51. The loading platform 50 also has a peripheral wall part 53 extending downward from the peripheral part of the top board part 51. A pair of rail members (a left rail member 55L and a right rail member 55R), each of which has a rail groove, are formed on the front side of the lower surface of the top board part 51. A pair of attachment parts (a left attachment part 56L and a right attachment part 56R), which are separated from each other laterally, are formed to vertically extend on the rear side of the lower surface of the top board part 51.

The extendable mechanism 70 is constructed to vertically extend and retract a pair of right and left X-shaped arms (also referred to as “pantograph arms”) and to raise and lower the loading platform 50 in parallel to the base 30. Normally, when the cart 10 is on a horizontal surface, that is, when the base 30 is disposed horizontally, the extendable mechanism 70 extends and retracts. That is, by extending and retracting the pair of right and left X-shaped arms vertically, the extendable mechanism 70 can horizontally raise and lower the loading platform 50. According to the present example, the extendable mechanism 70 is formed as an X-shaped link mechanism in which two right X-shaped arms are vertically stacked on each other and two left X-shaped arms are vertically stacked on each other.

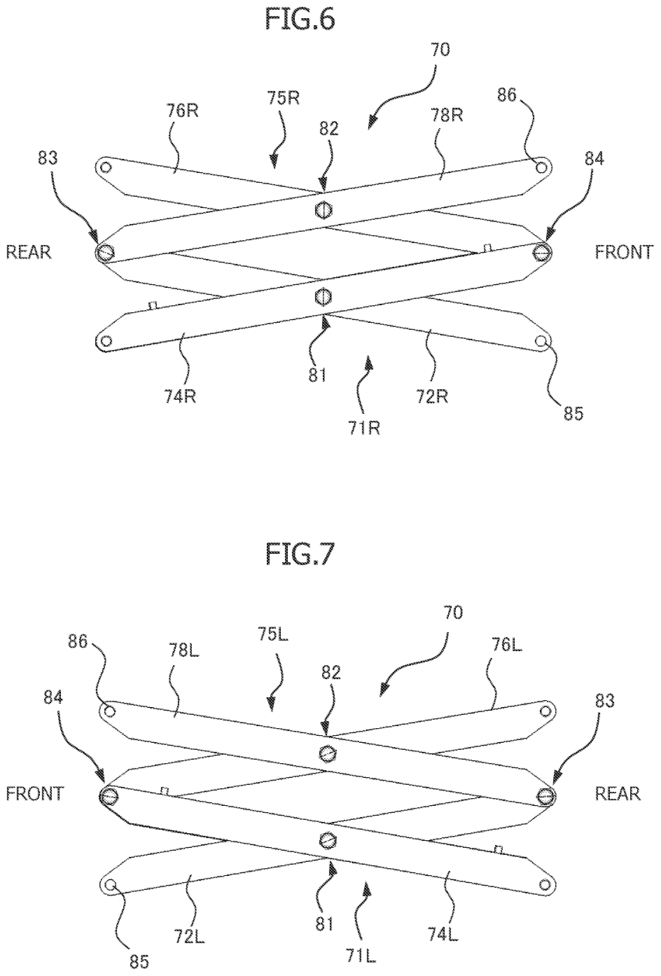

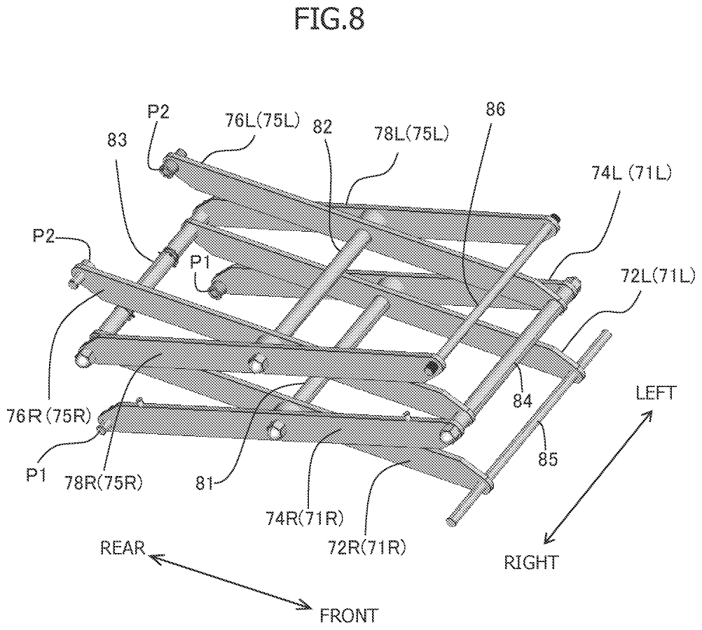

FIGS. 6 to 8 illustrate the construction of the extendable mechanism 70. FIG. 6 is a view of the extendable mechanism 70 from the right, FIG. 7 is a view of the extendable mechanism 70 from the left, and FIG. 8 is a perspective view of the extendable mechanism 70.

As illustrated in FIGS. 6 to 8, according to the present example, the extendable mechanism 70 includes a pair of lower right and left X-shaped arms (a lower left X-shaped arm 71L and a lower right X-shaped arm 71R) and a pair of upper right and left X-shaped arms (an upper left X-shaped arm 75L and an upper right X-shaped arm 75R).

Each of the lower left X-shaped arm 71L and the lower right X-shaped arm 71R, which form the pair of lower right and left X-shaped arms, is formed by a lower inner arm and a lower outer arm that cross each other in the shape of the letter “X” in side view. The lower inner arm and the lower outer arm are coupled to each other in such a manner that these arms can mutually rotate. Specifically, according to the present example, the lower left X-shaped arm 71L is formed by a lower inner arm 72L and a lower outer arm 74L, and the center portions thereof are rotatably attached to each other near the left end of a lower coupling shaft 81 extending laterally (see FIGS. 7 and 8). Similarly, the lower right X-shaped arm 71R is formed by a lower inner arm 72R and a lower outer arm 74R, and the center portions thereof are rotatably attached to each other near the right end of the lower coupling shaft 81 (see FIGS. 6 and 8).

Each of the upper left X-shaped arm 75L and the upper right X-shaped arm 75R, which form the pair of upper right and left X-shaped arms, is formed by an upper inner arm and an upper outer arm that cross each other in the shape of the letter “X” in side view. The upper inner arm and the upper outer arm are coupled to each other in such a manner that these arms can mutually rotate. Specifically, according to the present example, the upper left X-shaped arm 75L is formed by an upper inner arm 76L and an upper outer arm 78L, and the center portions thereof are rotatably attached to each other near the left end of an upper coupling shaft 82 extending laterally above the lower coupling shaft 81 (see FIGS. 7 and 8). Similarly, the upper right X-shaped arm 75R is formed by an upper inner arm 76R and an upper outer arm 78R, and the center portions thereof are rotatably attached to each other near the right end of the upper coupling shaft 82 (see FIGS. 6 and 8).

In addition, the pair of lower right and left X-shaped arms (the lower left X-shaped arm 71L and the lower right X-shaped arm 71R) and the pair of upper right and left X-shaped arms (the upper left X-shaped arm 75L and the upper right X-shaped arm 75R) are coupled to each other via a rear coupling shaft 83 and a front coupling shaft 84 extending laterally.

Specifically, according to the present example, the rear end of the lower inner arm 72L of the lower left X-shaped arm 71L and the rear end of the upper outer arm 78L of the upper left X-shaped arm 75L are rotatably attached to each other near the left end of the rear coupling shaft 83 (see FIGS. 7 and 8). The rear end of the lower inner arm 72R of the lower right X-shaped arm 71R and the rear end of the upper outer arm 78R of the upper right X-shaped arm 75R are rotatably attached to each other near the right end of the rear coupling shaft 83 (see FIGS. 6 and 8).

In addition, the front end of the lower outer arm 74L of the lower left X-shaped arm 71L and the front end of the upper inner arm 76L of the upper left X-shaped arm 75L are rotatably attached to each other near the left end of the front coupling shaft 84 (see FIGS. 7 and 8). The front end of the lower outer arm 74R of the lower right X-shaped arm 71R and the front end of the upper inner arm 76R of the upper right X-shaped arm 75R are rotatably attached to each other near the right end of the front coupling shaft 84 (see FIGS. 6 and 8).

The front end of the lower inner arm 72L of the lower left X-shaped arm 71L is rotatably attached inside the left end of a lower movable shaft 85, which extends laterally below the front coupling shaft 84 and is movable longitudinally (see FIGS. 7 and 8). The front end of the lower inner arm 72R of the lower right X-shaped arm 71R is rotatably attached inside the right end of the lower movable shaft 85 (see FIGS. 6 and 8).

The left end of the lower movable shaft 85 is inserted into the left rail part 35L formed on the left frame member 32L of the base 30, and the right end of the lower movable shaft 85 is inserted into the right rail part 35R formed on the right frame member 32R of the base 30 (see FIGS. 3 to 8). That is, according to the present example, both ends of the lower movable shaft 85 are supported by the left rail part 35L and the right rail part 35R formed on the base 30, and are movable longitudinally along the left rail part 35L and the right rail part 35R.

In addition, the rear end of the lower outer arm 74L of the lower left X-shaped arm 71L is rotatably fixed to the left attachment part 36L formed on the rear end of the base 30 via a pin member P1. The rear end of the lower outer arm 74R of the lower right X-shaped arm 71R is rotatably fixed to the right attachment part 36R formed on the rear end of the base 30 via a pin member P1 (see FIGS. 3 to 8).

The front end of the upper outer arm 78L of the upper left X-shaped arm 75L is rotatably attached inside the left end of an upper movable shaft 86, which extends laterally above the front coupling shaft 84 and is movable longitudinally (see FIGS. 7 and 8). The front end of the upper outer arm 78R of the upper right X-shaped arm 75R is rotatably attached inside the right end of the upper movable shaft 86 (see FIGS. 6 and 8).

The left end of the upper movable shaft 86 is inserted into the rail groove of the left rail member 55L, which is formed on the bottom surface of the loading platform 50 (the top board part 51), and the right end of the upper movable shaft 86 is inserted into the rail groove of the right rail member 55R, which pairs with the left rail member 55L and is formed on the bottom surface of the loading platform 50 (the top board part 51) (see FIGS. 1 to 4 and FIGS. 6 to 8). That is, according to the present example, both ends of the upper movable shaft 86 are supported by the left rail member 55L and the right rail member 55R formed on the bottom surface of the loading platform 50, and are movable longitudinally along the rail groove of the left rail member 55L and the rail groove of the right rail member 55R.

In addition, the rear end of the upper inner arm 76L of the upper left X-shaped arm 75L is rotatably fixed to the left attachment part 56L formed to vertically extend on the bottom surface of the loading platform 50 (the top board part 51) via a pin member P2 (see FIG. 2, FIG. 4, and FIGS. 6 to 8). In addition, the rear end of the upper inner arm 76R of the upper right X-shaped arm 75R is rotatably fixed to the right attachment part 56R, which pairs with the left attachment part 56L and is formed to vertically extend on the bottom surface of the loading platform 50 (the top board part 51), via a pin member P2 (see FIG. 2, FIG. 3, FIGS. 6 to 8).

The drive device 90 is installed on the installation part 37 located inside and below the base 30. The drive device 90 rotates an electric motor as a drive source, to vertically extend and retract the pair of lower right and left X-shaped arms (the lower left X-shaped arm 71L and the lower right X-shaped arm 71R) and the pair of upper right and left X-shaped arms (the upper left X-shaped arm 75L and the upper right X-shaped arm 75R) of the extendable mechanism 70. In this way, the drive device 90 raises and lowers the loading platform 50.

In addition, according to the present example, the drive device 90 is constructed to have a back drive property. Specifically, the drive device 90 is constructed such that the electric motor as a drive source rotates when an external force (and change in external force) raises or lowers the loading platform 50 and the extendable mechanism 70 (the pair of lower left and right X-shaped arms and the pair of upper left and right X-shaped arms) consequently extends or retracts vertically.

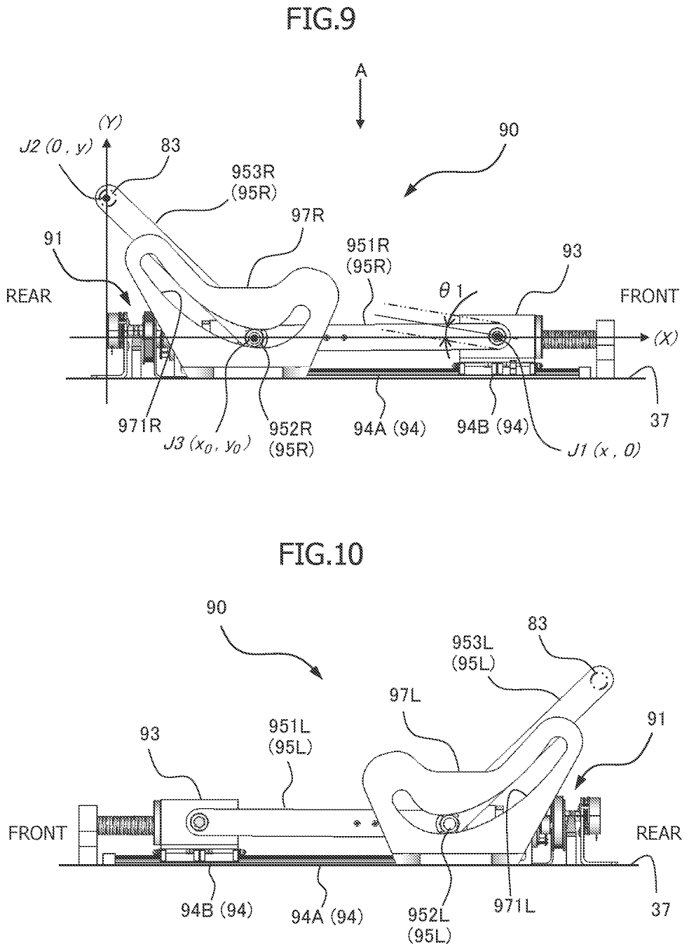

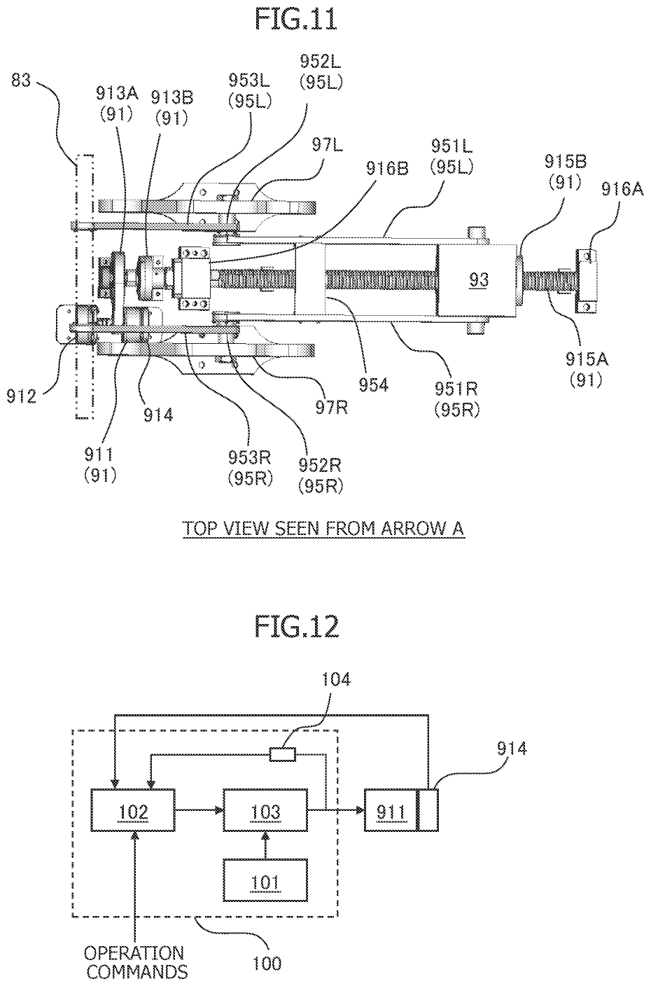

FIGS. 9 to 11 illustrate the construction of the drive device 90. FIG. 9 is a view of the drive device 90 from the right, FIG. 10 is a view of the drive device 90 from the left, and FIG. 11 is a top view seen from an arrow A in FIG. 9.

As illustrated in FIGS. 9 to 11, according to the present example, the drive device 90 includes an electric actuator 91, a movable part 93 that is driven and moved by the electric actuator 91, and a pair of right and left link mechanisms (a left link mechanism 95L and a right link mechanism 95R) and a pair of right and left guide members (a left guide member 97L and a right guide member 97R) used as a coupling mechanism for coupling the movable part 93 and the extendable mechanism 70.

The electric actuator 91 is a linear actuator that converts the rotational motion of the electric motor as a drive source into linear motion by using a ball screw mechanism and outputs the linear motion. According to the present example, the electric actuator 91 includes an electric motor (a servo motor) 911, a pulley-belt mechanism 913A and a planetary gear mechanism 913B used as a speed reduction mechanism, and a ball screw mechanism (a ball screw shaft 915A and a ball screw nut 915B).

The operation of the electric motor 911 is controlled by the control device 100. A non-excited brake 912 is attached to the output shaft of the electric motor 911, for example, via a coupling, and an encoder (a rotation sensor) 914 that detects the rotation of the electric motor 911 and outputs a signal is attached to the electric motor 911.

The pulley-belt mechanism 913A and the planetary gear mechanism 913B used as a speed reduction mechanism reduce the speed of the rotation of the output shaft of the electric motor 911 and transfer the resultant rotation to the ball screw shaft 915A. The pulley-belt mechanism 913A constitutes the first stage of the speed reduction mechanism, and the planetary gear mechanism 913B constitutes the second stage of the speed reduction mechanism. That is, according to the present example, the speed of the rotation of the electric motor 911 is reduced in the two stages, and the resultant rotation is transferred to the ball screw mechanism (the ball screw shaft 915A). However, the present invention is not limited to this example. The number of stages of the speed reduction mechanism is not limited to any particular number, as long as the above back drive property is not impaired.

The ball screw shaft 915A extends longitudinally and is rotatably supported by supporting members 916A and 916B to which a bearing (not illustrated) is attached. The ball screw shaft 915A is rotated by the electric motor 911 via the pulley-belt mechanism 913A and the planetary gear mechanism 913B. The ball screw nut 915B is threadably mounted on the ball screw shaft 915A and moves in the axial direction on the ball screw shaft 915A along with the rotation of the ball screw shaft 915A (that is, the ball screw nut 915B moves linearly and longitudinally).

The movable part 93 is fixed to the ball screw nut 915B and moves with the ball screw nut 915B. According to the present example, a linear slider 94 is installed below the ball screw shaft 915A. The linear slider 94 includes a slide rail 94A extending longitudinally and a slide block 94B moving on the slide rail 94A. The lower part of the movable part 93 fixed to the ball screw nut 915B is fixed to the slide block 94B.

The left link mechanism 95L and the right link mechanism 95R as the coupling mechanism are constructed to push and pull the rear coupling shaft 83 of the extendable mechanism 70 along with the movement of the movable part 93. Consequently, the left link mechanism 95L and the right link mechanism 95R vertically extend and retract the pair of lower right and left X-shaped arms (the lower left X-shaped arm 71L and the lower right X-shaped arm 71R) and the pair of upper right and left X-shaped arms (the upper left X-shaped arm 75L and the upper right X-shaped arm 75R).

Specifically, according to the present example, the left link mechanism 95L includes a first link member 951L of which the front end is rotatably coupled to the left side of the movable part 93 and a second link member 953L of which the rear end is rotatably coupled to the rear coupling shaft 83 of the extendable mechanism 70 (that is, the pair of lower right and left X-shaped arms 71L and 71R and the pair of upper right and left X-shaped arms 75L and 75R) and of which the front end is rotatably coupled to the rear end of the first link member 951L via a shaft member 952L. Similarly, the right link mechanism 95R includes a first link member 951R of which the front end is rotatably coupled to the right side of the movable part 93 and a second link member 953R of which the rear end is rotatably coupled to the rear coupling shaft 83 of the extendable mechanism 70 and of which the front end is rotatably coupled to the rear end of the first link member 951R via a shaft member 952R. In addition, the first link member 951L of the left link mechanism 95L and the first link member 951R of the right link mechanism 95R are coupled to each other via a coupling plate 954.

The left guide member 97L and the right guide member 97R are disposed behind the installation part 37 located inside and below the base 30, and are disposed on the left side and the right side of the electric actuator 91. The left guide member 97L has a guide hole 971L for guiding the shaft member 952L of the left link mechanism 95L that moves with the movement of the movable part 93. In addition, the right guide member 97R has a guide hole 971R for guiding the shaft member 952R of the right link mechanism 95R that moves with the movement of the movable part 93. The guide hole 971L in the left guide member 97L and the guide hole 971R in the right guide member 97R are formed to have the same shape.

For example, the shape of the guide hole 971L in the left guide member 97L and the guide hole 971R in the right guide member 97R are determined as follows. Hereinafter, although the shape of the guide hole 971R in the right guide member 97R will be described with reference to FIG. 9, the following description also applies to the shape of the guide hole 971L in the left guide member 97L.

First, when the loading platform 50 is raised or lowered between its lowest position and its highest position, a first coupling part J1 where the movable part 93 and the front end of the first link member 951R are coupled to each other moves on the X axis, and a second coupling part J2 where the second link member 953R and the rear coupling shaft 83 coupled to each other moves on the Y axis (see FIG. 9).

Next, a relationship between the position (x,0) of the first coupling part J1 and the position (0,y) of the second coupling part J2, that is, a relationship between x and y, is determined by a physical law (herein, principle of virtual work). The relationship between y and x (for example, dy/dx) may be expressed by a constant or may be a linear or non-linear relationship. The present example assumes that the relationship (dy/dx) between y and x is expressed by a constant. Therefore, as will be described below, when the loading platform 50 is raised from its lowest position to its highest position, the electric actuator 91 (electric motor 911) maintains its output at approximately the same level.

Next, a displacement angle θ1 (an angle from the X axis) of the first link member 951R is determined based on the inverse kinematics or the geometrical relationship of the mechanism, specifically, based on the relationship among the position (x,0) of the first coupling part J1, a length L1 of the first link member 951R, the position (0,y) of the second coupling part J2, and a length L2 of the second link member 953R.

Next, the position (x0,y0) of a center J3 of the shaft member 952R is determined based on the position (x,0) of the first coupling part J1, the length L1 of the first link member 951R, and the displacement angle θ1 of the first link member 951R. By connecting the determined position (x0,y0) of the center J3 of the shaft member 952R, the shape of the guide hole 971R is determined. There are two solutions for the displacement angle θ1 of the first link member 951R (there are two possible values for the displacement angle θ1). The present example adopts the smaller one of the two solutions (the two values) for the displacement angle θ1 of the first link member 951R, mainly to minimize the size of the guide holes 971L and 971R. As a result, the guide holes 971L and 971R have the shapes as illustrated in FIGS. 9, 10, etc.

The guide hole 971R is formed to have a curved shape such that the shaft member 952R can be smoothly moved therein. In the present example, the guide hole 971R is formed to have a curved shape approximately like the letter “U” (or “V”). In this way, when the movable part 93 is moved in the direction that raises the loading platform 50, the shaft member 952R is first moved diagonally downward in the rear direction, and is next moved diagonally upward in the rear direction.

The control device 100 is installed adjacent to the electric motor 911 on the installation part 37 located inside and below the base 30. FIG. 12 illustrates a schematic configuration of the control device 100. As illustrated in FIG. 12, the control device 100 includes a power supply 101, a control circuit 102, a motor drive circuit 103, and a current sensor 104 that detects a current (a motor drive current) flowing through the electric motor 911 and outputs a signal. In addition, the control circuit 102 receives the output signals from the encoder 914 and the current sensor 104 and operation commands about the loading platform 50 via an input unit (not illustrated).

The control device 100 (the control circuit 102) controls the electric motor 911 based on the operation commands for the loading platform 50, the operation commands being input via the input unit. In the present example, examples of the operation commands include an up command for raising the loading platform 50, a down command for lowering the loading platform 50, and a stop command for stopping the raising or lowering of the loading platform 50. The input of the stop command signifies stopping of the input of the up command and/or stopping of the input of the stop command Upon receiving the up command, the control device 100 rotates the electric motor 911 in a first direction (this rotation will be hereinafter referred to as “normal rotation”). Upon receiving the down command, the control device 100 rotates the electric motor 911 in a second direction opposite to the first direction (this rotation will be hereinafter referred to as “reverse rotation”). In addition, upon receiving the stop command, the control device 100 controls the electric motor 911 such that the loading platform 50 is held at its current vertical position.

In addition, in the present example, when the loading platform 50 is held at a predetermined vertical position, if the control device 100 detects lowering of the loading platform 50 based on the output signal of the encoder 914 and detects an increase in motor drive current based on the output signal of the current sensor 104, in other words, increase in weight of the load placed on the loading platform 50, the control device 100 controls the electric motor 911 such that the lowered loading platform 50 is raised up to the predetermined vertical position and is held at the predetermined vertical position.

In addition, in the present example, when the loading platform 50 is held at a predetermined vertical position, if the control device 100 detects raising of the loading platform 50 based on the output signal of the encoder 914 and detects a decrease in motor drive current based on the output signal of the current sensor 104, that is, decrease in weight of the load placed on the loading platform 50, the control device 100 controls the electric motor 911 such that the raised loading platform 50 is lowered down to the predetermined vertical position and is held at the predetermined vertical position.

Next, operation examples of the cart 10 will be described.

### (Raising and Lowering Operations of Loading Platform 50)

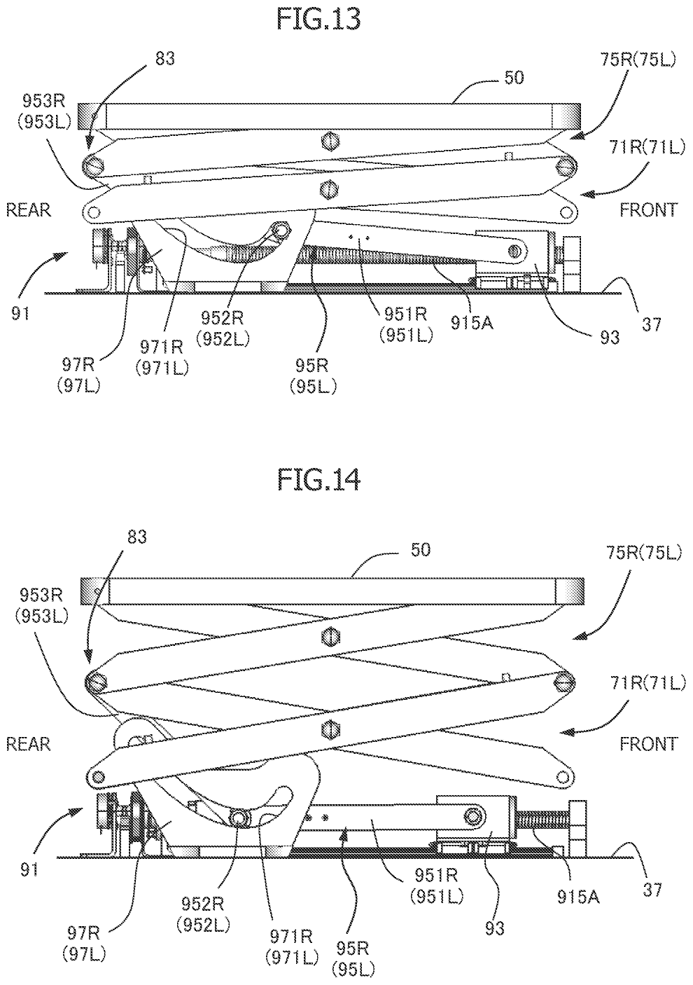

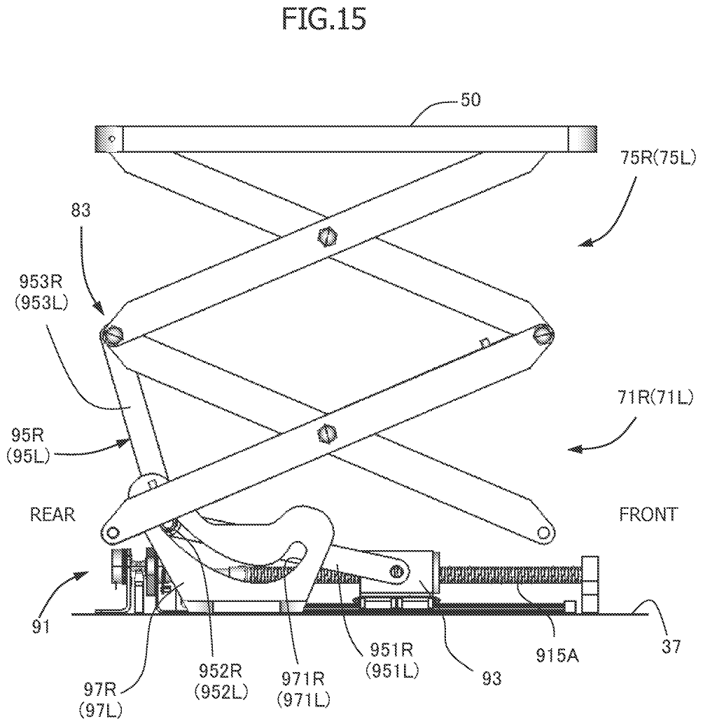

FIG. 13 illustrates the state of the extendable mechanism 70 and the drive device 90 when the loading platform 50 is located at its lowest position. FIG. 14 illustrates the state of the extendable mechanism 70 and the drive device 90 when the loading platform 50 is located at an intermediate position. FIG. 15 illustrates the state of the extendable mechanism 70 and the drive device 90 when the loading platform 50 is located at its highest position.

For example, when the loading platform 50 is located at its lowest position, if an operator enters the up command to the input unit, the control device 100 causes the electric motor 911 to perform the normal rotation. Accordingly, the movable part 93 is moved backward, and the rear coupling shaft 83 of the extendable mechanism 70 is raised by the left link mechanism 95L (the first link member 951L, the shaft member 952L, and the second link member 953L) and the right link mechanism 95R (the first link member 951R, the shaft member 952R, and the second link member 953R). As a result, the extendable mechanism 70, more specifically, the pair of lower right and left X-shaped arms (the lower left X-shaped arm 71L and the lower right X-shaped arm 71R) and the pair of upper right and left X-shaped arms (the upper left X-shaped arm 75L and the upper right X-shaped arm 75R), extends upward, and the loading platform 50 is consequently raised. When the loading platform 50 reaches its highest position, the control device 100 stops the normal rotation of the electric motor 911 and controls the electric motor 911 such that the loading platform 50 is held at its highest position (FIG. 13→FIG. 14→FIG. 15).

In addition, for example, when the loading platform 50 is located at its highest position, if the operator enters the down command to the input unit, the control device 100 causes the electric motor 911 to perform the reverse rotation. Accordingly, the movable part 93 is moved forward, and the rear coupling shaft 83 of the extendable mechanism 70 is lowered by the left link mechanism 95L and the right link mechanism 95R. As a result, the extendable mechanism 70, more specifically, the pair of lower right and left X-shaped arms (the lower left X-shaped arm 71L and the lower right X-shaped arm 71R) and the pair of upper right and left X-shaped arms (the upper left X-shaped arm 75L and the upper right X-shaped arm 75R), retracts downward, and the loading platform 50 is consequently lowered. When the loading platform 50 reaches its lowest position, the control device 100 stops the reverse rotation of the electric motor 911 (FIG. 15→FIG. 14→FIG. 13).

When the loading platform 50 has been raised or lowered to an intermediate position, if the operator enters the stop command to the input unit, the control device 100 stops the normal rotation or the reverse rotation of the electric motor 911 and controls the electric motor 911 such that the loading platform 50 is held at its current vertical position (the intermediate position) (FIG. 14).

In the present example, the non-excited brake 912 is attached to the output shaft of the electric motor 911. Thus, even when the power supply to the electric motor 911 is stopped, the loading platform 50 is held at its current position.

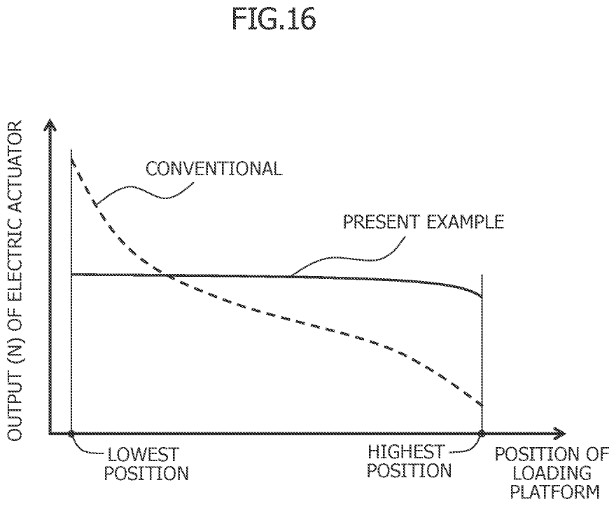

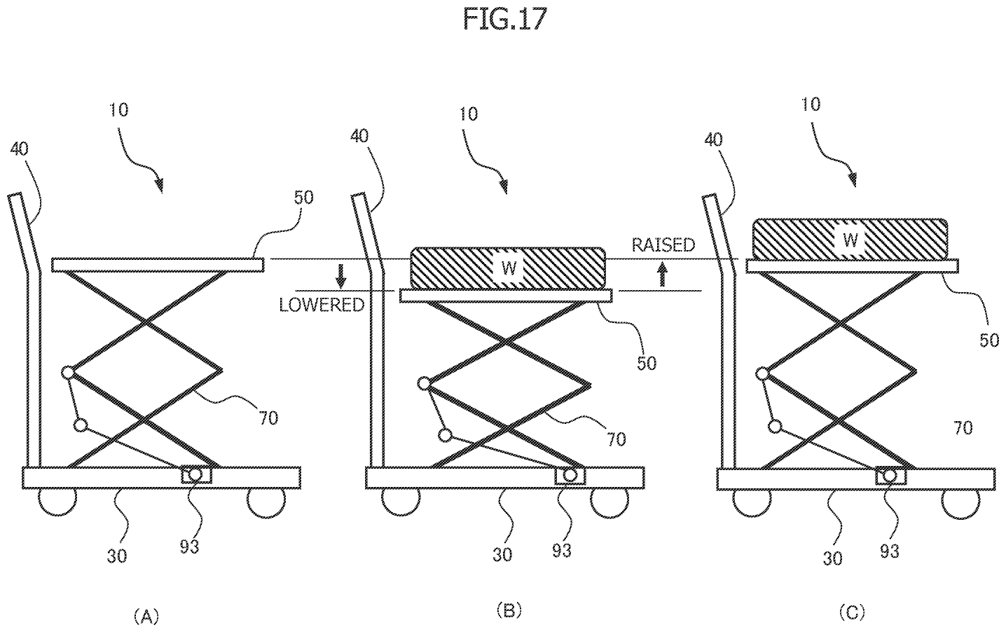

FIG. 16 illustrates an example of a result of a comparison between the cart 10 according to the present example and a conventional cart of the same kind. Specifically, FIG. 16 illustrates the outputs of the electric actuators of these carts when their respective loading platforms on which a load is placed are raised from their lowest position to their highest position.

As indicated by a dashed line in FIG. 16, in the case of the conventional cart of the same kind, the output of the electric actuator for raising the loading platform located at its lowest position is at its maximum level, and next, the output of the electric actuator decreases as the loading platform is raised. In contrast, in the case of the cart 10 according to the present example, as indicated by a solid line in FIG. 16, the output of the electric actuator for raising the loading platform 50 located at its the lowest position is less than that of the conventional cart of the same kind. In addition, the output F of the electric actuator 91 is held at approximately the same level during the raising of the loading platform 50 from its lowest position to its highest position. Accordingly, the loading platform 50 is raised from its lowest position to its highest position at a constant speed.

### (Operation When Load is Placed on Loading Platform 50)

FIG. 17 illustrates an operation example of the cart 10 when a load is placed on the loading platform 50.

First, an operator enters the up command to the input unit, to raise the loading platform 50 located at its lowest position to a predetermined vertical position (hereinafter referred to as “first vertical position”) (FIG. 17A). As a result, the control device 100 controls the electric motor 911 such that the loading platform 50 is held at the first vertical position.

Next, the operator places a load W on the loading platform 50 held at the first vertical position. As described above, in the present example, the drive device 90 has a back drive property. That is, the drive device 90 is constructed such that the electric motor 911 rotates as an external force (or change in external force) raises or lowers the loading platform 50 and consequently extends or retracts the extendable mechanism 70 vertically. Thus, when the load W is placed on the loading platform 50, the weight of the placed load W (that is, increase in weight of the load placed on the loading platform 50) lowers the loading platform 50 from the first vertical position and retracts the extendable mechanism 70 downward (FIG. 17B). As a result, the electric motor 911 rotates in the second direction. This rotation of the electric motor 911 in the second direction is detected by the encoder 914, and the encoder 914 outputs a signal based on the rotation of the electric motor 911 in the second direction to the control device 100 (the control circuit 102). The control circuit 102 of the control device 100 also receives the output signal of the current sensor 104.

The control device 100 (the control circuit 102) detects the rotation of the electric motor 911 in the second direction based on the output signal of the encoder 914 (that is, the lowering of the loading platform 50) and detects an increase in motor drive current based on the output signal of the current sensor 104. Accordingly, the control device 100 determines that the placement of the load W on the loading platform 50 has increased the weight of the load placed on the loading platform 50 and has consequently lowered the loading platform 50 from the first vertical position at which the loading platform 50 has been held. In this case, the control device 100 controls the electric motor 911 such that the lowered loading platform 50 is raised and held at the first vertical position.

For example, the control device 100 calculates the amount of increase in motor drive current based on the output signal of the current sensor 104, and estimates the amount of increase in weight of the load placed on the loading platform 50 based on the calculated amount of increase in motor drive current. In addition, the control device 100 calculates the number of rotations of the electric motor 911 in the second direction based on the output signal of the encoder 914, and estimates the amount of the lowering of the loading platform 50 from the first vertical position based on the calculated number of rotations. The control device 100 may calculate the rotation speed of the electric motor 911 in the second direction based on the output signal of the encoder 914, and may estimate the amount of increase in weight of the load placed on the loading platform 50 based on the calculated rotation speed and the calculated amount of increase in motor drive current. In addition, the control device 100 increases the output (torque) of the electric motor 911 based on the estimated amount of increase in weight of the load placed on the loading platform 50, causes the electric motor 911 to perform the normal rotation based on the estimated amount of the lowering so as to raise the loading platform 50, and holds the loading platform 50 at this position. As a result, the loading platform 50 is held at the first vertical position even after the load W is placed (FIG. 17C).

(Operation When Load is Removed from Loading Platform 50)

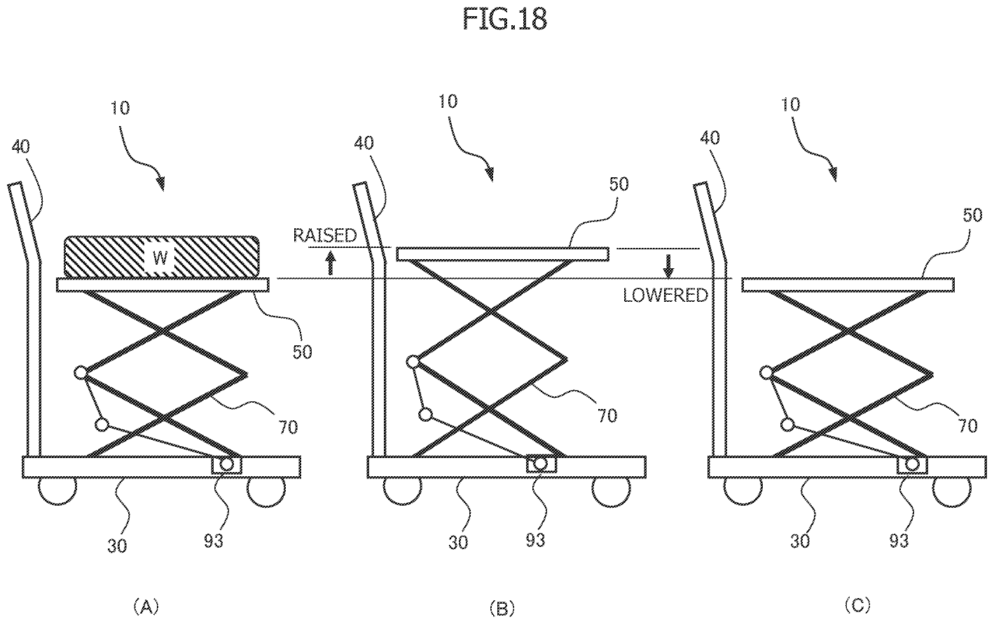

FIG. 18 illustrates an operation example of the cart 10 when a load is removed from the loading platform 50.

FIG. 18A illustrates the cart 10 when a load W is placed on the loading platform 50 and the loading platform 50 is held at a predetermined vertical position (hereinafter referred to as “second vertical position”). In this case, the control device 100 controls the electric motor 911 such that the loading platform 50 is held at the second vertical position.

When the operator removes the load W from the loading platform 50 held at the second vertical position, the weight of the load placed on the loading platform 50 is reduced by the removed load W. As a result, the electric motor 911 rotates in the first direction, and the loading platform 50 is raised from the second vertical position (FIG. 18B). This rotation of the electric motor 911 in the first direction is detected by the encoder 914, and the encoder 914 outputs a signal based on the rotation of the electric motor 911 in the first direction to the control device 100 (the control circuit 102). The control circuit 102 of the control device 100 also receives the output signal of the current sensor 104.

The control device 100 (the control circuit 102) detects the rotation of the electric motor 911 in the first direction (that is, the raising of the loading platform 50) based on the output signal of the encoder 914 and detects a decrease in motor drive current based on the output signal of the current sensor 104. Accordingly, the control device 100 determines that the removal of the load W from the loading platform 50 has decreased the weight of the load placed on the loading platform 50 and has consequently raised the loading platform 50 from the second vertical position at which the loading platform 50 has been held. In this case, the control device 100 controls the electric motor 911 such that the raised loading platform 50 is lowered and held at the second vertical position.

For example, the control device 100 calculates the amount of decrease in motor drive current based on the output signal of the current sensor 104, and estimates the amount of decrease in weight of the load placed on the loading platform 50 based on the calculated amount of decrease in motor drive current. In addition, the control device 100 calculates the number of rotations of the electric motor 911 in the first direction based on the output signal of the encoder 914, and estimates the amount of the raising of the loading platform 50 from the second vertical position based on the calculate number of rotations. The control device 100 may calculate the rotation speed of the electric motor 911 in the first direction based on the output signal of the encoder 914, and may estimate the amount of decrease in weight of the load placed on the loading platform 50 based on the calculated rotation speed and the calculated amount of decrease in motor drive current. In addition, the control device 100 causes the electric motor 911 to perform the reverse rotation based on the estimated amount of the raising so as to lower the loading platform 50, decreases the output (torque) of the electric motor 911 based on the estimated amount of decrease in weight of the load placed on the loading platform 50, and holds the loading platform 50 at this position. As a result, the loading platform 50 is held at the second vertical position even after the load W is removed (FIG. 18C).

As described above, the drive device 90 of the cart 10 according to the first example includes the electric motor 911 as a drive source. The rotation of the electric motor 911 extends or retracts the extendable mechanism 70 vertically, and the loading platform 50 consequently is raised or lowered. In addition, the control device 100 controls the electric motor 911 such that the loading platform 50 is raised or lowered to a predetermined vertical position and is held at the predetermined vertical position based on an operation command about the loading platform 50. The drive device 90 has a back drive property. That is, the drive device 90 is constructed such that the electric motor 911 rotates as an external force (change in external force) raises or lowers the loading platform 50 and consequently extends and retracts the extendable mechanism 70 vertically. When a load is placed on the loading platform 50 of the cart 10 and the weight of the load placed on the loading platform 50 is consequently increased, the loading platform 50 is lowered from its current vertical position (the first vertical position). Thus, impacts that a load receives from the loading platform 50 when the load is placed on the loading platform 50 can be reduced. In particular, for example, when a load is tossed onto the loading platform 50, the impact load is applied to the loading platform 50, and the loading platform 50 is consequently lowered more promptly. Therefore, it is possible to reduce occurrence of damage to the load, for example.

In addition, when the control device 100 detects the lowering of the loading platform 50 from the first vertical position and detects an increase in weight of the load placed on the loading platform 50 based on the output signals of the encoder 914 and the current sensor 104, the control device 100 controls the electric motor 911 such that the lowered loading platform 50 is raised to the first vertical position and is held at the first vertical position. Thus, before and after the placement of a load on the loading platform 50, the loading platform 50 can be held at the same position. The present invention is not limited to the operations described above. The control device 100 may control the electric motor 911 such that the electric motor 911 promptly stops the loading platform 50 when the control device 100 detects lowering of the loading platform 50 from the first vertical position. In this case, the loading platform 50 is held at a vertical position lower than the first vertical position.

On the other hand, when a load is removed from the loading platform 50 and the weight of the load placed on the loading platform 50 is decreased, the loading platform 50 is raised from its currently-held vertical position (the second vertical position). In this case, when the control device 100 detects the raising of the loading platform 50 from the second vertical position and decrease in weight of the load placed on the loading platform 50 based on the output signals of the encoder 914 and the current sensor 104, the control device 100 controls the electric motor 911 such that the raised loading platform 50 is lowered to the second vertical position and is held at the second vertical position. Thus, before and after the removal of a load from the loading platform 50, the loading platform 50 can be held at the same position. The present invention is not limited to the operations described above. The control device 100 may control the electric motor 911 such that the electric motor 911 promptly stops the loading platform 50 when the control device 100 detects raising of the loading platform 50 from the second vertical position. In this case, the loading platform 50 is held at a vertical position higher than the second vertical position.

### Second Example

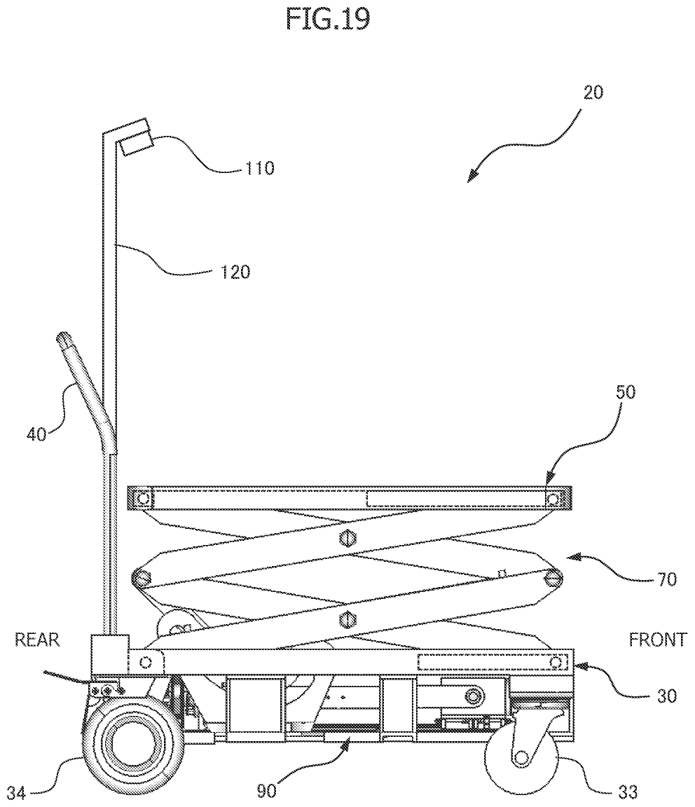

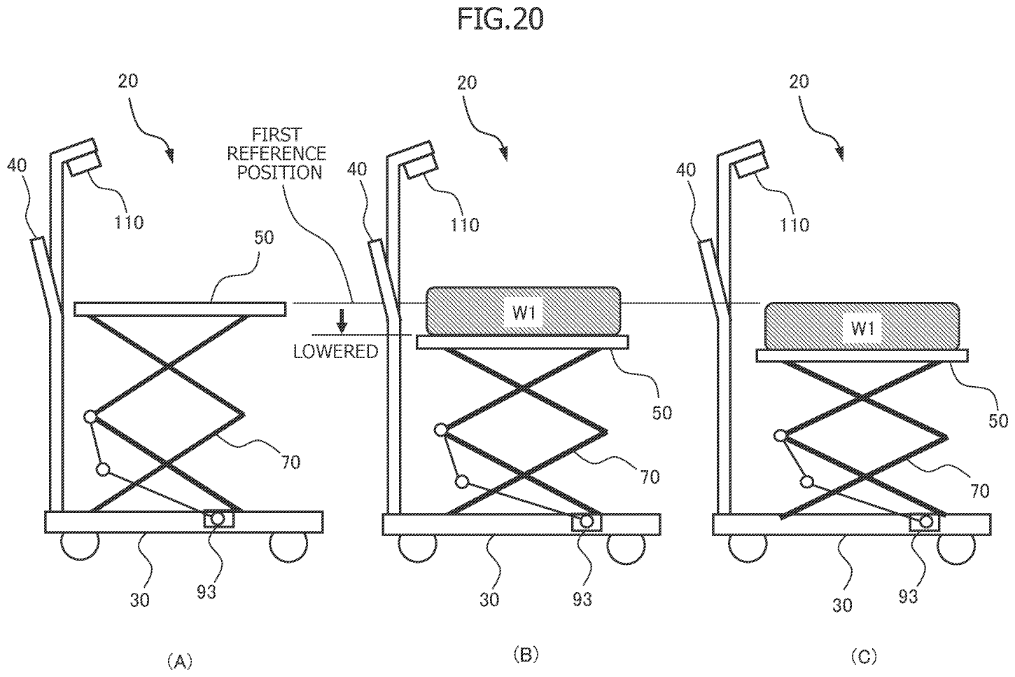

FIG. 19 is a view of a push handle cart 20 according to a second example from the right. A main difference between the cart 10 according to the first example and the cart 20 according to the second example is that the cart 20 according to the second example further includes a position detection unit 110 that can detect the vertical position of the top surface of the loading platform 50 and the vertical position of the top surface of a load placed on the loading platform 50. The cart 20 according to the second example includes components, which are the same as those of the cart 10 according to the first example. Thus, these components will be denoted by the same reference numerals, and description thereof will be omitted. The following description will be mainly made on the difference between the cart according to the second example and the cart 10 according to the first example.

The position detection unit 110 of the cart 20 according to the second example includes a TOF range image sensor that sets a predetermined range on the top surface of the loading platform 50 as its range area, for example. The position detection unit 110 is disposed at a predetermined position on a support 120 attached to the handle 40, the predetermined position being located above the handle 40, and is disposed to face the loading platform 50. As with the handle 40, the support 120 has an approximately gate shape (an approximately inverted U-shape), for example, and holds the position detection unit 110 via a bracket (not illustrated).

When no load is placed on the loading platform 50, the position detection unit 110 can detect the vertical position of the top surface of the loading platform 50. When a load is placed on the loading platform 50, the position detection unit 110 can detect the vertical position of the top surface of the load placed on the loading platform 50. The position detected by the position detection unit 110 is output to the control device 100.

When the control device 100 of the cart 20 according to the second example receives the stop command (or when the loading platform 50 is held at the predetermined vertical position), the control device 100 stores the position detected by the position detection unit 110 then as a reference position and controls the electric motor 911 such that the position detected by the position detection unit 110 maintains the reference position until the vertical position at which the loading platform 50 is held is changed.

Next, operation examples of the cart 20 according to the second example will be described. Because the raising and lowering operations of the loading platform 50 are the same as those of the cart 10 according to the first example, description thereof will be omitted. The following description will be made for “an operation when a load is placed on the loading platform 50” and “an operation when a load is removed from the loading platform 50”.

### (Operation When Load is Placed on Loading Platform 50)

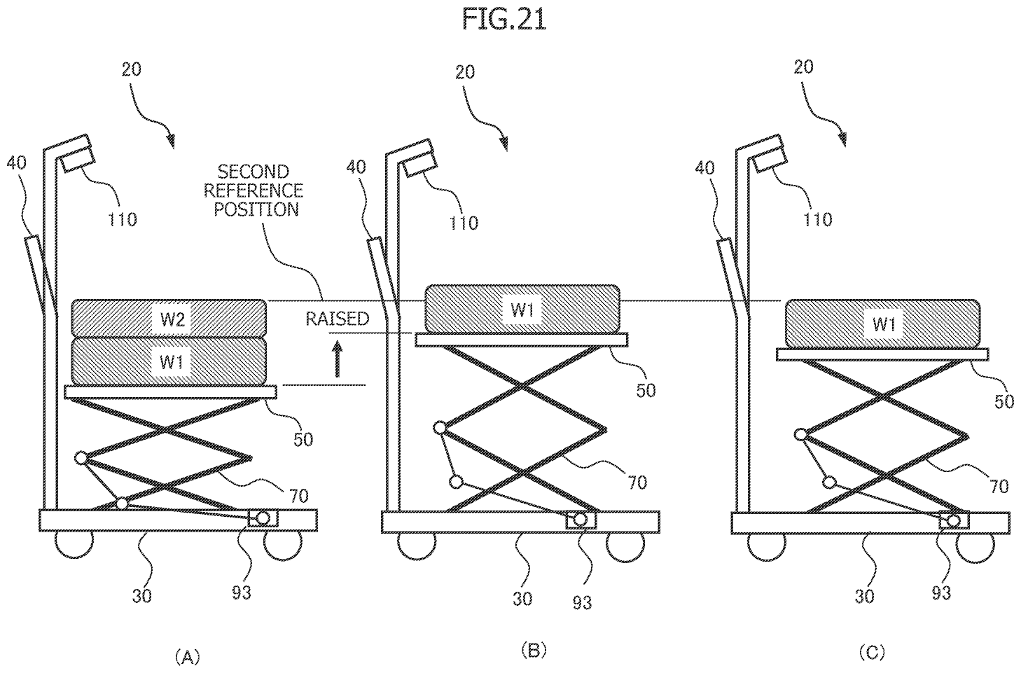

FIG. 20 illustrates an operation example of the cart 20 when a load is placed on the loading platform 50.

First, an operator enters the up command to the input unit, to raise the loading platform 50 located at its lowest position to a predetermined vertical position (hereinafter referred to as “third vertical position”) (FIG. 20A). Thus, the control device 100 controls the electric motor 911 such that the loading platform 50 is held at the first vertical position. In addition, the control device 100 stores the position detected by the position detection unit 110 (in this case, the vertical position of the top surface of the loading platform 50) as a reference position (hereinafter referred to as “first reference position”).

Next, the operator places a load W1 on the loading platform 50 held at the third vertical position. When the load W1 is placed on the loading platform 50, the weight of the placed load W1 (that is, the increase in weight of the load placed on the loading platform 50) lowers the loading platform 50 from the third vertical position and retracts the extendable mechanism 70 downward (FIG. 19B). As a result, the electric motor 911 rotates in the second direction. This rotation of the electric motor 911 in the second direction is detected by the encoder 914, and the encoder 914 outputs a signal based on the rotation of the electric motor 911 in the second direction to the control device 100 (the control circuit 102). The control circuit 102 of the control device 100 also receives the output signal of the current sensor 104.

The control device 100 (the control circuit 102) detects the rotation of the electric motor 911 in the second direction (that is, the lowering of the loading platform 50) based on the output signal of the encoder 914 and detects an increase in motor drive current based on the output signal of the current sensor 104. Accordingly, the control device 100 determines that the placement of the load on the loading platform 50 has increased the weight of the load placed on the loading platform 50 and has consequently lowered the loading platform 50 from the first vertical position. In this case, the control device 100 controls the electric motor 911 such that the lowered loading platform 50 is held at a fourth vertical position lower than the third vertical position.

For example, when the control device 100 detects the rotation of the electric motor 911 in the second direction based on the output signal of the encoder 914, the control device 100 calculates the amount of increase in motor drive current based on the output signal of the current sensor 104, and estimates the amount of increase in weight of the load placed on the loading platform 50 based on the calculated amount of increase in motor drive current. The control device 100 may calculate the rotation speed of the electric motor 911 in the second direction based on the output signal of the encoder 914, and may estimate the amount of increase in weight of the load placed on the loading platform 50 based on the calculated rotation speed and the calculated amount of increase in motor drive current. Next, the control device 100 increases the output (torque) of the electric motor 911 based on the estimated amount of increase in weight of the load placed on the loading platform 50 and controls the electric motor 911 such that the position detected by the position detection unit 110 (in this case, the vertical position of the top surface of the load W1 placed on the loading platform 50) matches the first reference position. The control device 100 may control the electric motor 911 by causing the electric motor 911 to perform the normal rotation and/or the reverse rotation. As a result, the top surface of the load W1 placed on the loading platform 50 matches the first reference position (that is, the position of the top surface of the loading platform 50 before the placement of the load W), and the loading platform 50 is held at the fourth vertical position lower than the third vertical position (FIG. 20C).

Although not illustrated, when a load W2 is additionally placed on the loading platform 50, specifically, when a load W2 is additionally placed on the load W1, the control device 100 controls the electric motor 911 such that the position detected by the position detection unit 110 (the vertical position of the top surface of the added load W2) matches the first reference position. As a result, the loading platform 50 is held at a vertical position lower than the fourth vertical position.

(Operation When Load is Removed from Loading Platform 50)

FIG. 21 illustrates an operation example of the cart 20 when a load is removed from the loading platform 50.

FIG. 21A illustrates the cart 10 when loads W1 and W2 are placed on the loading platform 50 and the loading platform 50 is held at a predetermined vertical position (hereinafter referred to as “fifth vertical position”). In this case, the control device 100 controls the electric motor 911 such that the loading platform 50 is held at the fifth vertical position. In addition, the control device 100 stores the position detected by the position detection unit 110 (in this case, the vertical position of the top surface of the load W2 placed on the loading platform 50) as a reference position (hereinafter referred to as “second reference position”).

When an operator removes the load W2 from the loading platform 50 held at the fifth vertical position, the weight of the load placed on the loading platform 50 is reduced by the removed load W2. As a result, the electric motor 911 rotates in the first direction, and the loading platform 50 is raised from the fifth vertical position (FIG. 21B). This rotation of the electric motor 911 in the first direction is detected by the encoder 914, and the encoder 914 outputs a signal based on the rotation of the electric motor 911 in the first direction to the control device 100 (the control circuit 102). The control circuit 102 of the control device 100 also receives the output signal of the current sensor 104.

The control device 100 (the control circuit 102) detects the rotation of the electric motor 911 in the first direction (that is, the raising of the loading platform 50) based on the output signal of the encoder 914 and detects a decrease in motor drive current based on the output signal of the current sensor 104. Accordingly, the control device 100 determines that the removal of the load from the loading platform 50 has decreased the weight of the load placed on the loading platform 50 and has consequently raised the loading platform 50 from the fifth vertical position. In this case, the control device 100 controls the electric motor 911 such that the raised loading platform 50 is held at a sixth vertical position higher than the fifth vertical position.

For example, when the control device 100 detects the rotation of the electric motor 911 in the first direction based on the output signal of the encoder 914, the control device 100 calculates the amount of decrease in motor drive current based on the output signal of the current sensor 104, and estimates the amount of decrease in weight of the load placed on the loading platform 50 based on the calculated amount of decrease in motor drive current. The control device 100 may calculate the rotation speed of the electric motor 911 in the first direction based on the output signal of the encoder 914, and may estimate the amount of decrease in weight of the load placed on the loading platform 50 based on the calculated rotation speed and the calculated amount of decrease in motor drive current. In addition, the control device 100 decreases the output (torque) of the electric motor 911 based on the estimated amount of decrease in weight of the load placed on the loading platform 50 and controls the electric motor 911 such that the position detected by the position detection unit 110 (in this case, the vertical position of the load W1 remaining on the loading platform 50) matches the second reference position. The control device 100 may control the electric motor 911 by causing the electric motor 911 to perform the normal rotation and/or the reverse rotation. As a result, the top surface of the load W1 remaining on the loading platform 50 matches the second reference position (that is, the vertical position of the top surface of the load W2), and the loading platform 50 is held at the sixth vertical position higher than the fifth vertical position (FIG. 21C).

Although not illustrated, when the load W1 is also removed from the loading platform 50, there will be no load on the loading platform 50. Thus, the control device 100 controls the electric motor 911 such that the position of the top surface of the loading platform 50 detected by the position detection unit 110 matches the second reference position. As a result, the loading platform 50 is held at a vertical position higher than the sixth vertical position.

As described above, since the drive device 90 of the cart 20 according to the second example has a back drive property, when a load is placed on the loading platform 50 and the weight of the load placed on the loading platform 50 is increased, the loading platform 50 is lowered from its current vertical position. Thus, as with the cart 10 according to the first example, in the case of the cart 20 according to the second example, too, impacts that a load receives from the loading platform 50 when the load is placed on the loading platform 50 are reduced.

In addition, the control device 100 detects lowering of the loading platform 50 from the third vertical position and detects an increase in weight of the load placed on the loading platform 50 based on the output signals of the encoder 914 and the current sensor 104. When the control device 100 detects lowering of the loading platform 50 from the third vertical position and increase in weight of the load placed on the loading platform 50, the control device 100 controls the electric motor 911 such that the loading platform 50 is held at the fourth vertical position lower than the third vertical position. Specifically, the control device 100 controls the electric motor 911 such that the position detected by the position detection unit 110 (the vertical position of the top surface of the load placed on the loading platform 50) matches the first reference position (the vertical position of the top surface of the loading platform 50 before the placement of the load). Thus, in particular, when an operator places a plurality of loads on the loading platform 50, the vertical position on which the individual loads are placed is maintained approximately at the same level. Thus, the operator's burden of placing the loads on the loading platform 50 can be reduced.

On the other hand, when the load W2 is removed from the loading platform 50 and the weight of the load placed on the loading platform 50 is reduced, the loading platform 50 is raised from its currently-held vertical position (the fifth vertical position). Accordingly, the control device 100 detects the raising of the loading platform 50 from the fifth vertical position and the decrease in weight of the load placed on the loading platform 50 based on the output signals of the encoder 914 and the current sensor 104. When the control device 100 detects the raising of the loading platform 50 from the fifth vertical position and the decrease in weight of the load placed on the loading platform 50, the control device 100 controls the electric motor 911 such that the loading platform 50 is held at the sixth vertical position higher than the fifth vertical position. Specifically, the control device 100 controls the electric motor 911 such that the position detected by the position detection unit 110 (the vertical position of the top surface of the load W1 remaining on the loading platform 50) matches the second reference position (the vertical position of the top surface of the load W2 before the removal from the loading platform 50). Thus, when the operator removes a plurality of loads from the loading platform 50, the vertical position from which the loads are removed is maintained at approximately the same level. Thus, the operator's burden of removing the loads from the loading platform 50 can be reduced.

In the individual examples described above, the extendable mechanism 70 is formed as an X-shaped link mechanism in which a pair of right and left X-shaped arms are vertically stacked in two stages. However, the present invention is not limited to this example. The extendable mechanism 70 may be formed as an X-shaped link mechanism having a pair of right and left X-shaped arms in one stage or in three or more stages.

In addition, in the drive device 90 according to the individual examples described above, the left guide member 97L has the guide hole 971L for guiding the shaft member 952L of the left link mechanism 95L that moves with the movement of the movable part 93, and the right guide member 97R has the guide hole 971R for guiding the shaft member 952R of the right link mechanism 95R that moves with the movement of the movable part 93. However, the present invention is not limited to this example. The left guide member 97L may have a guide groove instead of the guide hole 971L, and/or the right guide member 97R may have a guide groove instead of the guide hole 971R.

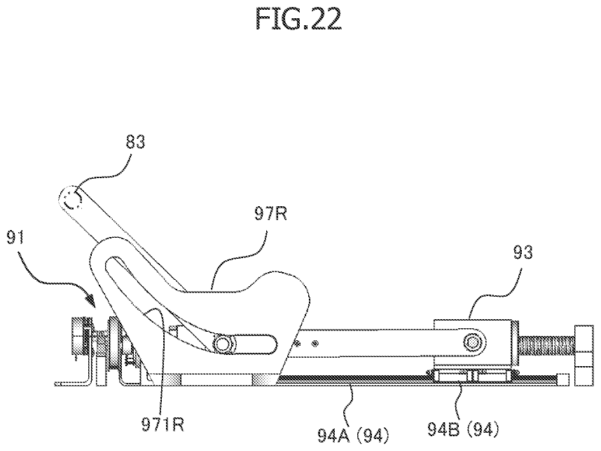

In addition, in the individual examples described above, the guide hole 971L of the left guide member 97L and the guide hole 971R of the right guide member 97R are formed to have a curved shape approximately like the letter “U” (or “V”). In this way, when the movable part 93 is moved in the direction that raises the loading platform 50, the shaft members 952L and 952R are first moved diagonally downward in the rear direction and is next moved diagonally upward in the rear direction. However, the present invention is not limited to this example. The shape of the guide holes 971L and 971R varies depending on the length L1 of the first link members 951L and 951R and the length L2 of the second link members 953L and 953R. For example, as illustrated in FIG. 22 corresponding to FIG. 9, the guide hole 971L and the guide hole 971R may be formed such that the shaft members 952L and 952R will first be moved horizontally in the rear direction and will next be moved diagonally upward as the movable part 93 is moved in the direction that raises the loading platform 50.

If the longitudinal space for installing the electric actuator 91 is the same, the individual examples described above can adopt longer first link members 951L and 951R and/or longer second link members 953L and 953R than the modification illustrated in FIG. 21. As a result, the loading platform 50 can be raised to a higher position. In other words, if the loading platform 50 is raised to the same height, the individual examples described above need a smaller longitudinal space for installing the electric actuator 91 than the modification illustrated in FIG. 22. Therefore, when the longitudinal space for installing the electric actuator 91 is limited, which is usually the case with carts, the individual examples described above are more advantageous than the modification illustrated in FIG. 22.

In addition, in the above-described examples, the relationship (dy/dx) between y and x for determining the shape of the guide holes 971L and 971R is expressed by a constant. However, the present invention is not limited to this example. As described above, the relationship (dy/dx) between y and x may be a linear or a non-linear relationship. If the relationship between y and x varies, the shape of the guide holes 971L and 971R varies. If the shape of the guide holes 971L and 971R varies, the output of the electric actuator 91 that is needed to raise the loading platform 50 and the raising speed of the loading platform 50 vary. In other words, the raising characteristics of the loading platform 50 can be changed based on the shape of the guide holes 971L and 971R. Therefore, the carts 10 and 20 according to the examples are advantageous in that demands about the raising characteristics of the loading platform 50 can be accommodated relatively flexibly.

Although examples and modifications of the present invention have thus been described, the present invention is not limited thereto. Further variations and modifications are of course possible based on the basic technical concepts of the present invention.

### REFERENCE SYMBOL LIST

10, 20 Cart
30 Base
40 Handle
50 Loading platform
70 Extendable mechanism
71L Lower left X-shaped arm
71R Lower right X-shaped arm
72L, 72R Lower inner arm
74L, 74R Lower outer arm
75L Upper left X-shaped arm
75R Upper right X-shaped arm
76L, 76R Upper inner arm
78L, 78R Upper outer arm
81 Lower coupling shaft
82 Upper coupling shaft
83 Rear coupling shaft
84 Front coupling shaft
85 Lower movable shaft
86 Upper movable shaft
90 Drive device
91 Electric actuator
93 Movable part
94 Linear slider
95L Left link mechanism
95R Right link mechanism
97L Left guide member
97R Right guide member
100 Control device
104 Current sensor
110 Position detection unit
911 Electric motor
913A Pulley-belt mechanism
913B Planetary gear mechanism
914 Encoder (rotation sensor)
915A Ball screw shaft
915B Ball screw nut
951L, 951R First link member
952L, 952R Shaft member
953L, 953R Second link member
971L, 971R Guide hole (guide part)

1. A cart comprising:
a base having a lower part to which a wheel is attached;
a loading platform that is disposed above the base;
an extendable mechanism that is disposed between the base and the loading platform and that is capable of vertically extending and retracting;
a drive device that raises and lowers the loading platform by rotating an electric motor and consequently extending and retracting the extendable mechanism vertically;
a rotation sensor that detects the rotation of the electric motor and outputs a signal;
a current sensor that detects a drive current of the electric motor and outputs a signal; and
a control device that controls the electric motor such that the loading platform is raised or lowered to a predetermined vertical position based on an operation command and such that the loading platform is held at the predetermined vertical position,
wherein the drive device has a back drive property that rotates the electric motor when an external force raises or lowers the loading platform and consequently extends or retracts the extendable mechanism, and
wherein, when the control device detects lowering of the loading platform held at the predetermined vertical position and detects an increase in weight of a load placed on the loading platform based on the output signals of the rotation sensor and the current sensor, the control device controls the electric motor such that the lowered loading platform is raised and held at the predetermined vertical position or is held at a vertical position lower than the predetermined vertical position.

2. The cart according to claim 1, further comprising:
a position detection unit that is capable of detecting, when no load is placed on the loading platform, a vertical position of a top surface of the loading platform and detect, when a load is placed on the loading platform, a vertical position of a top surface of the load placed on the loading platform,
wherein, when the loading platform is held at the predetermined vertical position, the control device sets the position detected by the position detection unit as a first reference position, and
wherein, when the control device detects lowering of the loading platform held at the predetermined vertical position, the control device controls the electric motor such that the position detected by the position detection unit matches the first reference position.

3. The cart according to claim 1, wherein, when the control device detects raising of the loading platform held at the predetermined vertical position and detects a decrease in weight of the load placed on the loading platform based on the output signals of the rotation sensor and the current sensor, the control device controls the electric motor such that the raised loading platform is lowered and held at the predetermined vertical position or is held at a vertical position higher than the predetermined vertical position.

4. The cart according to claim 3, further comprising:
a position detection unit that is capable of detecting, when no load is placed on the loading platform, a vertical position of a top surface of the loading platform and detect, when a load is placed on the loading platform, a vertical position of a top surface of the load placed on the loading platform,
wherein, when the loading platform is held at the predetermined vertical position, the control device sets the position detected by the position detection unit as a second reference position, and
wherein, when the control device detects raising of the loading platform held at the predetermined vertical position, the control device controls the electric motor such that the position detected by the position detection unit matches the second reference position.

5. The cart according to claim 1,
wherein the extendable mechanism includes a pair of right and left X-shaped arms that are capable of vertically extending and retracting,
wherein the drive device includes the electric motor, a ball screw shaft that extends longitudinally and is rotated by the electric motor via a speed reduction mechanism, a ball screw nut that moves in an axial direction of the ball screw shaft along with the rotation of the ball screw shaft, a movable part that is integrally formed with the ball screw nut, a first link member having one end that is rotatably coupled to the movable part, a second link member having one end that is rotatably coupled to the pair of right and left X-shaped arms and having another end that is rotatably coupled to another end of the first link member via a shaft member, and a guide member having a guide part for guiding the shaft member that moves with movement of the movable part, and
wherein the drive device is constructed to vertically extend and retract the pair of right and left X-shaped arms via the first link member and the second link member along with movement of the movable part and to consequently raise and lower the loading platform.

6. The cart according to claim 5, wherein the guide part is formed such that the shaft member is first moved horizontally or diagonally downward and is next moved diagonally upward as the movable part is moved in a direction that raises the loading platform.

7. The cart according to claim 5, wherein the pair of right and left X-shaped arms are provided in a plurality of stages and are vertically stacked one on another.
